(19) United States
(12) Patent Application Publication
(10) Pub. No.: US 2016/0010840 A1
(43) Pub. Date: Jan. 14, 2016

(54) Thermally efficient OGC lamp

(71) Applicant: Wenchang Fan, Yuyao City (CN)

(72) Inventor: Wenchang Fan, Yuyao City (CN)

(21) Appl. No.: 14/860,731

(22) Filed: Sep. 22, 2015

(51) Int. Cl. F21V 29/58; F21K 99/00; F21V 31/00

(52) U.S. Cl. CPC F21V 29/58; F21V 31/005; F21K 9/135; F21Y 2101/02

(57) ABSTRACT

A thermally efficient OGC lamp includes a positive terminal; a negative terminal; a connecting member formed with the negative terminal; a circuit board disposed in the negative terminal and electrically connected to both the positive terminal and the negative terminal; a housing formed with the connecting member; a thermally efficient element filled in the housing; a sealing member disposed on the connecting member; a lens disposed on a bottom of the housing and being distal the connecting member; a plurality of LEDs disposed in the lens and electrically connected to the circuit board; conductors mounted on the housing; a silver plasma printed circuit formed on the LEDs; and a substrate formed on the silver plasma printed circuit. The conductors are electrically interconnected the circuit board and the silver plasma printed circuit which is electrically connected to the LEDs. The thermally efficient element is either oil or wax.

### CROSS-REFERENCE TO RELATED APPLICATIONS

This application is a continuation-in-part (CIP) of U.S. patent application Ser. No. 13/920,131, filed Jun. 18, 2013, now abandoned, which claims the benefit of priority of Chinese Patent Application No. 201310196313.4, filed May 24, 2013. The contents of the above applications are all incorporated herein by reference.

### BACKGROUND OF THE INVENTION

1. Field of the Invention

The invention relates to lamps and more particularly to a thermally efficient OGC (oil, glass, and chips) lamp.

2. Description of Related Art

Light-emitting diodes (LEDs) are renowned for their long useful life and ability to resist shock. LED has the advantages of efficiency, compactness, quick on/off time, prolonged lifetime, and shock resistance. There are a number of commercially available quality LED lamps. For example, 20W white LED lamp having a luminous flux of 700 Im and a luminance efficacy of 34 Im/W is produced by Edison Inc. A 100W white LED having a luminous flux of 600 Im and a luminance efficacy of 60 Im/W is produced by Edison Inc.

It has been found necessary to multiply the number of LED units to increase light output. However, this increase in number has also increased the amount of heat generated. Metal heat sink is typically provided as means for heat elimination. However, its performance is low, it is somewhat bulky, and its cost is relatively expensive.

Thus, how to effectively eliminate heat generated by a lit LED in a cost effective manner is a great issue to address.

### SUMMARY OF THE INVENTION

It is therefore one object of the invention to provide a t light source comprising a positive terminal; a negative terminal; a connecting member formed with the negative terminal; a circuit board disposed in the negative terminal and electrically connected to both the positive terminal and the negative terminal; a housing formed with the connecting member; a thermally efficient means filled in the housing; a sealing member disposed on the connecting member; a lens disposed on a bottom of the housing and being distal the connecting member; a plurality of LEDs disposed in the lens and electrically connected to the circuit board; and a plurality of conductors mounted on the housing; a silver plasma printed circuit formed on the LEDs; and a substrate formed on the silver plasma printed circuit; wherein the conductors are electrically interconnected the circuit board and the silver plasma printed circuit; and wherein the silver plasma printed circuit is electrically connected to the LEDs.

The above and other objects, features and advantages of the invention will become apparent from the following detailed description taken with the accompanying drawings.

### BRIEF DESCRIPTION OF THE DRAWINGS

FIG. 1 is a schematic side elevation of a thermally efficient OGC lamp according to a first preferred embodiment of the invention, the thermally efficient means being oil;

FIG. 2 is a schematic side elevation of a thermally efficient OGC lamp according to a second preferred embodiment of the invention, the thermally efficient means being wax;

FIG. 3 is a side elevation of a thermally efficient OGC lamp according to a third preferred embodiment of the invention, the thermally efficient means being oil;

FIG. 4 is a view similar to FIG. 3 showing illumination of the lamp;

FIG. 5 is a sectional view taken along line A-A of FIG. 3 showing a portion of the lamp above the line A-A;

FIG. 6 is a perspective view of FIG. 5;

FIG. 7 is a side elevation of a thermally efficient OGC lamp according to a fourth preferred embodiment of the invention, the thermally efficient means being oil; and

FIG. 8 is a sectional view taken along line B-B of FIG. 7 showing a portion of the lamp above the line B-B.

### DETAILED DESCRIPTION OF THE INVENTION

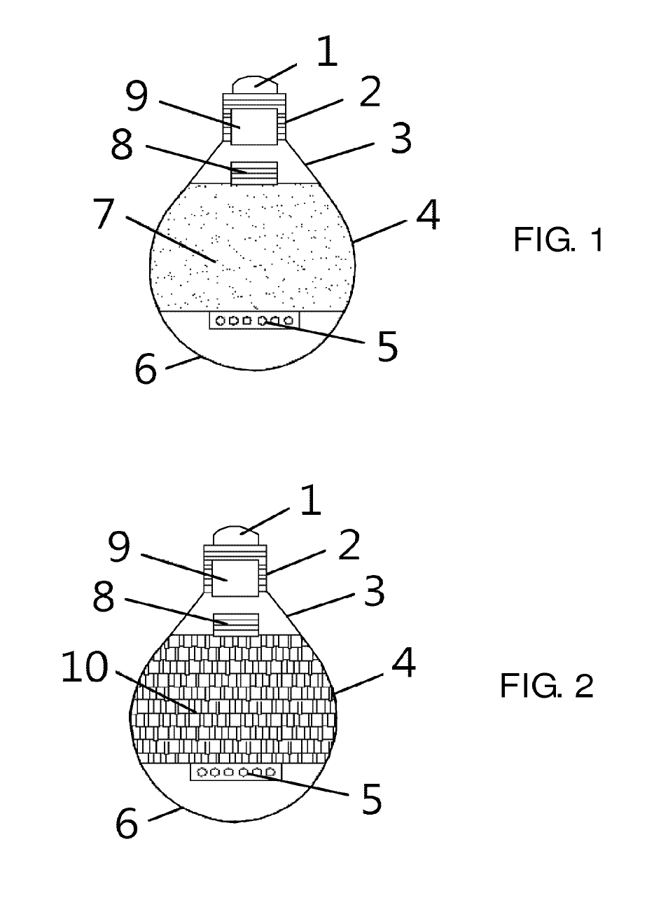

Referring to FIG. 1, a lamp in accordance with a first preferred embodiment of the invention comprises the following components as discussed in detail below.

A positive terminal 1 is served as a contact. An externally threaded negative terminal 2 is served as a base. An inverted funnel shaped connecting member 3 is formed with the negative terminal 2. A circuit board 9 is disposed substantially within the negative terminal 2. A housing 4 is formed with the connecting member 3. A thermally efficient means 7 is filled in the housing 4. A sealing member 8 is disposed on the connecting member 3 and contacts a joining edge of the connecting member 3 and the housing 4. A person may open the sealing member 8 to fill the thermally efficient means 7 into the housing 4. A bowl shaped lens 6 is disposed on a bottom of the housing 4. A plurality of LEDs (i.e., chips) 5 are disposed in the lens 6 and are electrically connected to the circuit board 9 which is in turn electrically connected to both the positive terminal 1 and the negative terminal 2.

Preferably, the housing 4 is formed of glass or ceramic.

Preferably, the thermally efficient means 7 is oil.

Preferably, the lens 6 is formed of glass or plastic.

It is envisaged by the invention that the glass or ceramic housing 4 is provided for eliminating the generated heat and the oil 7 is for further aiding the elimination of generated heat.

The lamp is thus called OGC lamp from acronym of its major components oil, glass, and chips.

Lighting principle of the invention is described in detail below. After mounting the positive terminal 1 and the negative terminal 2 in a socket, electric current is supplied from the circuit board 9 to the LEDs 5 for illumination. Heat generated by the LEDs 5 is substantially eliminated by both the oil 7 and the housing 4, thereby greatly increasing illumination. It is found that temperature of the LEDs 5 is kept between 45° C. and 55° C. and it is the preferred temperature range for prolonging the useful life of the LEDs 5 and thus the lamp.

Conventionally, a substrate of the LEDs is made of metal or ceramic and it adversely greatly decrease illumination.

Advantageously, a substrate of the LEDs 5 of the invention is formed of transparent glass secured to the housing 4 by means of silver plasma printed circuit. The substrate can increase illumination of the LEDs 5 by 30% to 50%.

Referring to FIG. 2, a lamp in accordance with a second preferred embodiment of the invention is shown. The characteristics of the second preferred embodiment are substantially the same as that of the first preferred embodiment except the following: The oil 7 is replaced with wax 10.

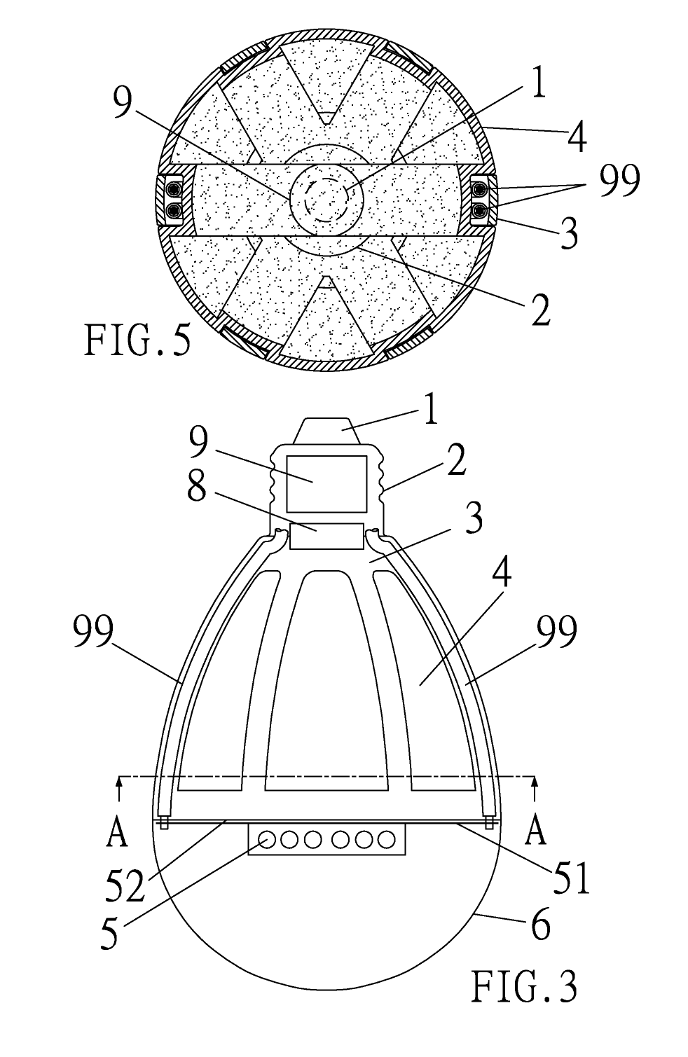

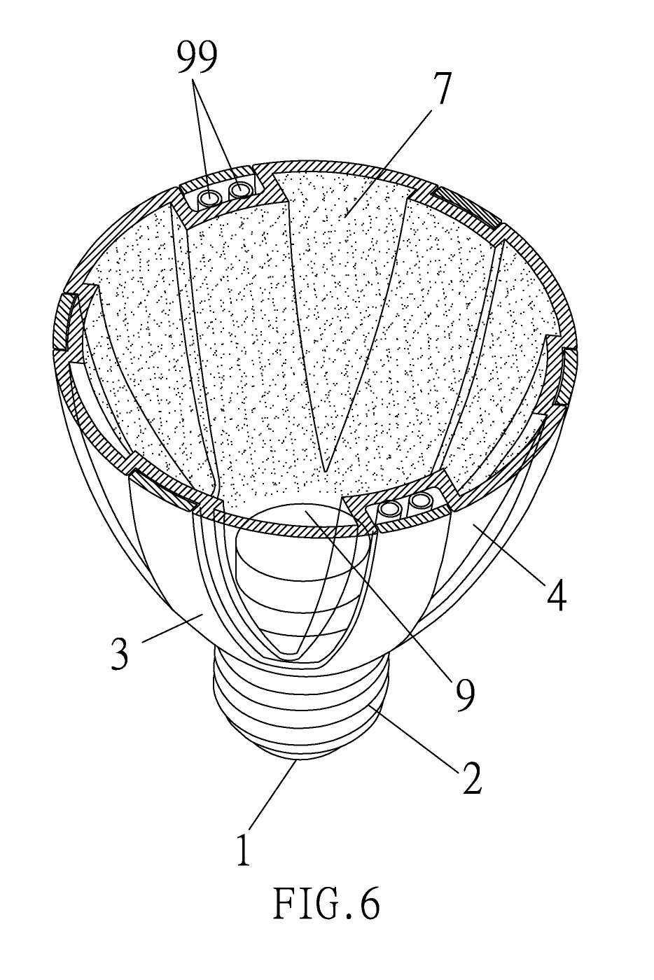

Referring to FIGS. 3 to 6, a lamp in accordance with a third preferred embodiment of the invention comprises the following components as discussed in detail below. The characteristics of the third preferred embodiment are substantially the same as that of the first preferred embodiment except the following: At least two wires (four are shown) 99 mounted on the housing 4 are electrically interconnected the circuit board 9 and a silver plasma printed circuit 51 which is in turn electrically connected to the LEDs 5.

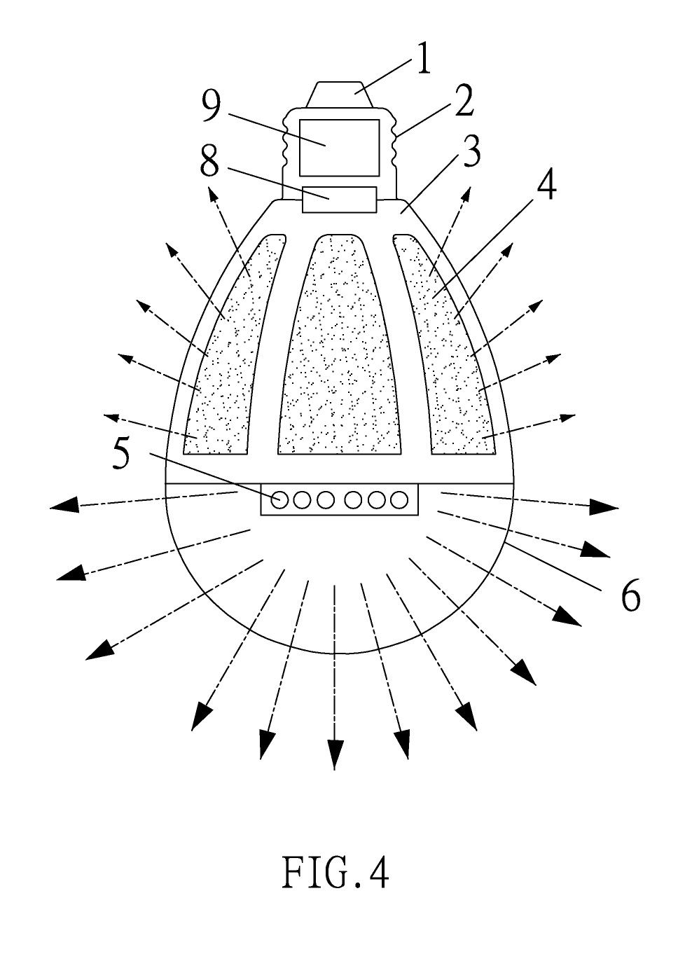

Advantageously, a substrate 52 of the LEDs 5 of the invention is formed of transparent glass secured to the housing 4 by means of the silver plasma printed circuit 51. The substrate can increase illumination of the LEDs 5 by 30% to 50% (see FIG. 4).

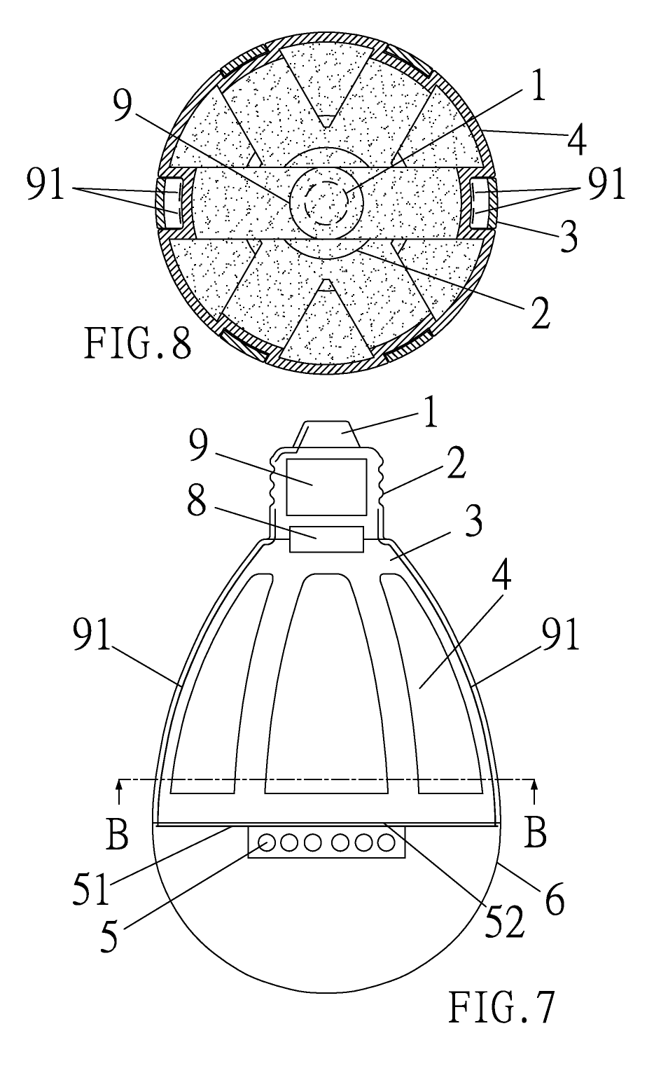

Referring to FIGS. 7 and 8, a lamp in accordance with a fourth preferred embodiment of the invention comprises the following components as discussed in detail below. The characteristics of the fourth preferred embodiment are substantially the same as that of the third preferred embodiment except the following: At least two conductors (four are shown) 91 mounted on the housing 4 are electrically interconnected the circuit board 9 and a silver plasma printed circuit 51 which is in turn electrically connected to the LEDs 5.

Advantageously, a substrate 52 of the LEDs 5 of the invention is formed of transparent glass secured to the housing 4 by means of the silver plasma printed circuit 51. The substrate can increase illumination of the LEDs 5 by 30% to 50% (see FIG. 4).

While the invention has been described in terms of preferred embodiments, those skilled in the art will recognize that the invention can be practiced with modifications within the spirit and scope of the appended claims.

What is claimed is:

1. A light source comprising:
a positive terminal;
a negative terminal;
a connecting member formed with the negative terminal;
a circuit board disposed in the negative terminal and electrically connected to both the positive terminal and the negative terminal;
a housing formed with the connecting member;
thermally efficient means filled in the housing;
a sealing member disposed on the connecting member;
a lens disposed on a bottom of the housing and being distal the connecting member;
a plurality of light-emitting diodes (LEDs) disposed in the lens and electrically connected to the circuit board;
a plurality of conductors mounted on the housing;
a silver plasma printed circuit formed on the LEDs; and
a substrate formed on the silver plasma printed circuit;
wherein the conductors are electrically interconnected the circuit board and the silver plasma printed circuit; and
wherein the silver plasma printed circuit is electrically connected to the LEDs.
